(19) United States
(12) Patent Application Publication
(10) Pub. No.: US 2024/0085672 A1
(43) Pub. Date: Mar. 14, 2024

(54) OPTICAL IMAGING SYSTEM

(71) Applicant: SAMSUNG ELECTRO-MECHANICS CO., LTD., Suwon-si (KR)

(72) Inventors: Byung Hyun KIM, Suwon-si (KR); Jong Pil KIM, Suwon-si (KR); Jae Hyuk HUH, Suwon-si (KR)

(73) Assignee: SAMSUNG ELECTRO-MECHANICS CO., LTD., Suwon-si (KR)

(21) Appl. No.: 18/099,539

(22) Filed: Jan. 20, 2023

(30) Foreign Application Priority Data
Sep. 14, 2022 (KR) 10-2022-0115665

(51) Int. Cl. G02B 13/00; G02B 9/60

(52) U.S. Cl. CPC G02B 13/0045; G02B 9/60

(57) ABSTRACT

An optical imaging system includes a first lens, a second lens, a third lens, a fourth lens, and a fifth lens, sequentially arranged from an object side, wherein the first lens has a positive refractive power, wherein the second lens has a negative refractive power, wherein the third lens has a refractive power, wherein the fourth lens has a refractive power, wherein the fifth lens has a refractive power, and wherein 2.0<f/(2×IMG HT)<3.0, and 0.16<D2/|f2|<0.3, where f is an overall focal length of the first lens to the fifth lens, IMG HT is half of a diagonal length of an imaging plane, D2 is a distance along an optical axis from an image-side surface of the second lens to an object-side surface of the third lens distance, and f2 is a focal length of the second lens.

### CROSS-REFERENCE TO RELATED APPLICATIONS

This application claims the benefit under 35 USC 119(a) of Korean Patent Application No. 10-2022-0115665 filed on Sep. 14, 2022, in the Korean Intellectual Property Office, the entire disclosure of which is incorporated herein by reference for all purposes.

### BACKGROUND

### 1. Field

The present disclosure relates to an optical imaging system.

### 2. Description of the Background

Camera modules may be used in portable electronic devices such as smartphones. Miniaturization of camera modules mounted in portable electronic devices may be due to miniaturization of such portable electronic devices.

In addition, as a level of functionality of camera modules in portable electronic devices has gradually increased, camera modules for mobile terminals have gradually been required to have high resolution.

Furthermore, telephoto cameras may capture high-magnification images with a large overall focal length.

The above information is presented as background information only to assist with an understanding of the present disclosure. No determination has been made, and no assertion is made, as to whether any of the above might be applicable as prior art with regard to the disclosure.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In one general aspect, an optical imaging system includes a first lens, a second lens, a third lens, a fourth lens, and a fifth lens, sequentially arranged from an object side, wherein the first lens has a positive refractive power, wherein the second lens has a negative refractive power, wherein the third lens has a refractive power, wherein the fourth lens has a refractive power, wherein the fifth lens has a refractive power, and wherein 2.0<f/(2χ IMG HT)<3.0, and 0.16<D2/|f2|<0.3, where f is an overall focal length of the first lens to the fifth lens, IMG HT is half of a diagonal length of an imaging plane, D2 is a distance along an optical axis from an image-side surface of the second lens to an object-side surface of the third lens distance, and f2 is a focal length of the second lens.

D2 may be greater than 1.7 mm and less than 3.5 mm.

f12/f may be greater than 0.9 and less than 2.5, where f12 is a synthetic focal length of the first lens and the second lens.

f12/D2 may be greater than 7.0 and less than 17.0.

|f1|/|f2| may be greater than 0.6 and less than 1.0, where f1 is a focal length of the first lens.

TTL/f may be greater than 0.8 and less than 1.2, where TTL is a distance along the optical axis from an object-side surface of the first lens to the imaging plane.

BFL/(2×IMG HT) may be greater than 0.7 and less than 1.5, where BFL is a distance along the optical axis from an image-side surface of the fifth surface to the imaging plane.

At least one of BFL/TTL may be greater than 0.3 and less than 0.6 and TD/TTL may be greater than 0.4 and less than 0.7, where BFL is a distance along the optical axis from an image-side surface of the fifth lens to the imaging plane, and TD is a distance along the optical axis from an object-side surface of the first lens to the image-side surface of the fifth lens.

n2+n3+n4 may be greater than 4.5 and less than 5.0, where n2 is a refractive index of the second lens, n3 is a refractive index of the third lens, and n4 is a refractive index of the fourth lens.

Each of the second to fourth lenses may have a refractive index greater than a refractive index of the first lens and a refractive index of the fifth lens.

Each of the second and fourth lenses may have a refractive index of 1.64 or more.

The first lens may have a form in which a length in a first axis direction, perpendicular to the optical axis, is greater than a length in a second axis direction, perpendicular to both the optical axis and the first axial direction, and f/(2×L1S1el) may be greater than 2.0 and less than 2.7, where L1S1el is a maximum effective radius of an object-side surface of the first lens.

L1S1el/L1S1es may be less than 1.0, where L1S1es is a minimum effective radius of the object-side surface of the first lens.

f1/(2×L1S1el) may be greater than 0.9 and less than 2.0, where f1 is a focal length of the first lens.

The second lens may have a form in which a length in the first axis direction is greater than a length in the second axis direction, and L1S1el/L2S1el may be greater than 1.0 and less than 1.2, where L2S1el is a maximum effective radius of an object-side surface of the second lens.

L1S1el/Min_el may be greater than 1.5 and less than 0.7, where Min_el is a smallest value, among effective radii of object-side surfaces of the third to fifth lenses.

The optical imaging system may further include an image sensor configured to convert light reflected from an object and refracted by the first lens, the second lens, the third lens, the fourth lens, and the fifth lens, into an electrical signal.

In another general aspect, an optical imaging system includes a first lens, a second lens, a third lens, a fourth lens, and a fifth lens, sequentially arranged along an optical axis from an object side, wherein the first lens has a positive refractive power, wherein the second lens has a negative refractive power, wherein the third lens has a refractive power, wherein the fourth lens has a refractive power, wherein the fifth lens has a refractive power, and wherein the first lens has a form in which a length in a first axis direction, perpendicular to the optical axis, is greater than a length in a second axis direction, perpendicular to both the optical axis and the first axial direction, and 2.0<f/(2×L1S1el)<2.7, where f is an overall focal length of the first lens to the fifth lens, and L1S1el is a maximum effective radius of an object-side surface of the first lens.

f/(2×IMG HT) may be greater than 2.0 and less than 3.0, and D2/|f2| may be greater than 0.16 and less than 0.3, where IMG HT is half of a diagonal length of an imaging plane, D2 is a distance along the optical axis from an image-side surface of the second lens to an object-side surface of the third lens distance, and f2 is a focal length of the second lens.

The optical imaging system may further include an image sensor configured to convert light reflected from an object and refracted by the first lens, the second lens, the third lens, the fourth lens, and the fifth lens, into an electrical signal, wherein D2 may be greater than 1.7 mm and less than 3.5 mm.

Other features and aspects will be apparent from the following detailed description, the drawings, and the claims.

### BRIEF DESCRIPTION OF DRAWINGS

FIG. 1 is a diagram illustrating a first example of an optical imaging system.

FIG. 2 is a diagram illustrating aberration characteristics of the optical imaging system illustrated in FIG. 1.

FIG. 3 is a diagram illustrating a second example of an optical imaging system.

FIG. 4 is a diagram illustrating aberration characteristics of the optical imaging system illustrated in FIG. 3.

FIG. 5 is a diagram illustrating a third example of an optical imaging system.

FIG. 6 is a diagram illustrating aberration characteristics of the optical imaging system illustrated in FIG. 5.

FIG. 7 is a diagram illustrating a fourth example of an optical imaging system.

FIG. 8 is a diagram illustrating aberration characteristics of the optical imaging system illustrated in FIG. 7.

FIG. 9 is a diagram illustrating a fifth example of an optical imaging system.

FIG. 10 is a diagram illustrating aberration characteristics of the optical imaging system illustrated in FIG. 9.

FIG. 11 is a diagram illustrating a sixth example of an optical imaging system.

FIG. 12 is a diagram illustrating aberration characteristics of the optical imaging system illustrated in FIG. 11.

FIG. 13 is a diagram illustrating a seventh example of an optical imaging system.

FIG. 14 is a diagram illustrating aberration characteristics of the optical imaging system illustrated in FIG. 13.

FIG. 15 is a diagram illustrating an eighth example of an optical imaging system.

FIG. 16 is a diagram illustrating aberration characteristics of the optical imaging system illustrated in FIG. 15.

FIG. 17 is a diagram illustrating an example in which a reflective member is included in the optical imaging system illustrated in FIG. 1.

FIG. 18 is a plan view illustrating an example of a lens having a non-circular shape of an optical image system.

Throughout the drawings and the detailed description, the same reference numerals refer to the same elements. The drawings may not be to scale, and the relative size, proportions, and depiction of elements in the drawings may be exaggerated for clarity, illustration, and convenience.

### DETAILED DESCRIPTION

Hereinafter, while examples of the present disclosure will be described in detail with reference to the accompanying drawings, it is noted that examples are not limited to the same.

The following detailed description is provided to assist the reader in gaining a comprehensive understanding of the methods, apparatuses, and/or systems described herein. However, various changes, modifications, and equivalents of the methods, apparatuses, and/or systems described herein will be apparent after an understanding of this disclosure. For example, the sequences of operations described herein are merely examples, and are not limited to those set forth herein, but may be changed as will be apparent after an understanding of this disclosure, with the exception of operations necessarily occurring in a certain order. Also, descriptions of functions and constructions that are known in the art may be omitted for increased clarity and conciseness.

The features described herein may be embodied in different forms, and are not to be construed as being limited to the examples described herein. Rather, the examples described herein have been provided merely to illustrate some of the many possible ways of implementing the methods, apparatuses, and/or systems described herein that will be apparent after an understanding of this disclosure.

Herein, it is noted that use of the term “may” with respect to an example or embodiment, e.g., as to what an example or embodiment may include or implement, means that at least one example or embodiment exists in which such a feature is included or implemented while all examples and embodiments are not limited thereto.

Throughout the specification, when an element, such as a layer, region, or substrate, is described as being “on,” “connected to,” or “coupled to” another element, it may be directly “on,” “connected to,” or “coupled to” the other element, or there may be one or more other elements intervening therebetween. In contrast, when an element is described as being “directly on,” “directly connected to,” or “directly coupled to” another element, there can be no other elements intervening therebetween.

As used herein, the term “and/or” includes any one and any combination of any two or more of the associated listed items; likewise, “at least one of” includes any one and any combination of any two or more of the associated listed items.

Although terms such as “first,” “second,” and “third” may be used herein to describe various members, components, regions, layers, or sections, these members, components, regions, layers, or sections are not to be limited by these terms. Rather, these terms are only used to distinguish one member, component, region, layer, or section from another member, component, region, layer, or section. Thus, a first member, component, region, layer, or section referred to in examples described herein may also be referred to as a second member, component, region, layer, or section without departing from the teachings of the examples.

Spatially relative terms such as “above,” “upper,” “below,” and “lower” may be used herein for ease of description to describe one element's relationship to another element as illustrated in the figures. Such spatially relative terms are intended to encompass different orientations of the device in use or operation in addition to the orientation depicted in the figures. For example, if the device in the figures is turned over, an element described as being “above” or “upper” relative to another element will then be “below” or “lower” relative to the other element. Thus, the term “above” encompasses both the above and below orientations depending on the spatial orientation of the device. The device may also be oriented in other ways (for example, rotated 90 degrees or at other orientations), and the spatially relative terms used herein are to be interpreted accordingly.

The terminology used herein is for describing various examples only, and is not to be used to limit the disclosure. The articles “a,” “an,” and “the” are intended to include the plural forms as well, unless the context clearly indicates otherwise. The terms “comprises,” “includes,” and “has” specify the presence of stated features, numbers, operations, members, elements, and/or combinations thereof, but do not preclude the presence or addition of one or more other features, numbers, operations, members, elements, and/or combinations thereof.

Due to manufacturing techniques and/or tolerances, variations of the shapes illustrated in the drawings may occur. Thus, the examples described herein are not limited to the specific shapes illustrated in the drawings, but include changes in shape that occur during manufacturing.

The features of the examples described herein may be combined in various ways as will be apparent after an understanding of this disclosure. Further, although the examples described herein have a variety of configurations, other configurations are possible as will be apparent after an understanding of this disclosure.

An aspect of the present disclosure is to provide an optical imaging system for capturing high-resolution images with a relatively large overall focal length.

In the lens configuration drawings, the thicknesses, sizes, and shapes of lenses have been slightly exaggerated for convenience of explanation. In particular, the shapes of spherical surfaces or aspherical surfaces illustrated in the drawings are illustrated by way of example.

An optical imaging system in the examples described herein includes a plurality of lenses disposed along an optical axis. The plurality of lenses are spaced apart from each other by preset distances along the optical axis.

In the examples described herein, the optical imaging system includes five lenses.

Among lenses constituting an optical imaging system, a forwardmost lens refers to a lens closest to an object side (or a reflective member), and a rearmost lens refers to a lens closest to an imaging plane (or an image sensor).

Further, in each lens, a first surface refers to a surface closest to the object side (or an object-side surface), and a second surface refers to a surface closest to the imaging plane (or an image-side surface). In addition, in the present specification, the numerical values for radii of curvature, thickness, and the like, of the lenses are all in millimeters (mm), and the unit of a field of view (FOV) is degrees.

Although it is described that one surface of a lens is convex, an edge portion of the lens may be concave. Likewise, although it is described that one surface of a lens is concave, an edge portion of the lens may be convex.

In addition, in the description of the shape of each lens, the meaning that one surface is convex indicates that the paraxial region portion of the surface is convex, and the meaning that one surface is concave indicates that the paraxial region portion of the surface is concave.

The paraxial region refers to a significantly narrow region near and including the optical axis.

The imaging surface may refer to a virtual surface on which a focus is formed by the optical imaging system. For example, the imaging surface may refer to one surface of an image sensor through which light is received.

The optical imaging system according to an example includes five lenses.

For example, the optical imaging system includes a first lens, a second lens, a third lens, a fourth lens, and a fifth lens arranged in order from the object side. The first lens to the fifth lens are arranged to be spaced apart from each other by a predetermined distance.

However, the optical imaging system according to the example is not only comprised of five lenses, and may further include other components.

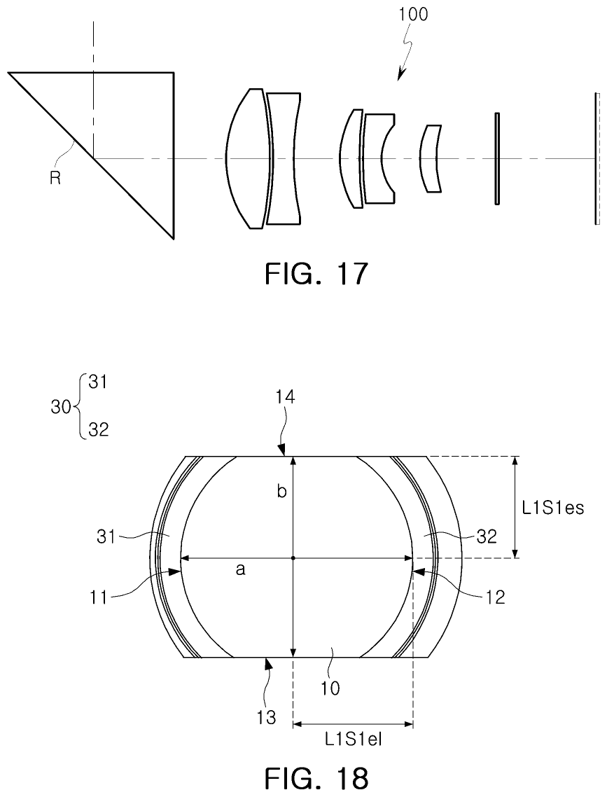

For example, referring to FIG. 17, the optical imaging system may further include a reflective member R having a reflective surface that changes an optical path. The reflective member R is configured to change the optical path by 90 degrees. As an example, the reflective member R may be a mirror or a prism.

The reflective member R may be disposed in front of the plurality of lenses. As an example, the reflective member R may be disposed in front of the first lens (that is, closer to the object side than the first lens is). Accordingly, in the present example, a lens disposed closest to the object side may be a lens disposed closest to the reflective member R.

In addition, the optical imaging system may further include an image sensor for converting an incident image of the object into an electrical signal.

In addition, the optical imaging system may further include an infrared blocking filter (hereinafter, referred to as a ‘filter’) for blocking infrared light. The filter is disposed between the lens (the fifth lens), disposed closest to the imaging plane, and the imaging plane.

In addition, the optical imaging system may further include a stop controlling the intensity of light.

All lenses, constituting the optical imaging system according to an example, may be formed of a plastic material.

Each lens may be formed of a plastic material having optical properties different from those of adjacent lenses. For example, each lens may be configured to have a refractive index and Abbe number different from those of adjacent lenses.

Referring to FIG. 18, at least some lenses of the optical imaging system may have a non-circular planar shape. For example, at least one of a first lens and a second lens may have a non-circular planar shape. The remaining lenses (for example, a third lens, a fourth lens, and a fifth lens) may have a circular planar shape.

The non-circular lens may have four side surfaces, and each of the two side surfaces may be formed to face each other. In addition, the side surfaces facing each other may be provided to have a corresponding shape.

For example, the first lens may have a first side surface, a second side surface, a third side surface, and a fourth side surface. The first side surface and the second side surface may be disposed on opposite sides of an optical axis, and the third side surface and the fourth side surface may be disposed on opposite sides with respect to the optical axis. Each of the third side surface and the fourth side surface may connect the first side surface and the second side surface to each other.

When viewed in an optical axis direction, the first side surface and the second side surface may have an arc shape, and the third side surface and the fourth side surface may have a substantially linear shape.

Each of the third side surface and the fourth side surface may connect the first side surface and the second side surface to each other. In addition, the third side surface and the fourth side surface are symmetrical with respect to the optical axis and may be parallel to each other.

A non-circular lens may have a first axis and a second axis intersecting the optical axis. For example, the first axis may be an axis connecting the first side surface and the second side surface to each other while passing through the optical axis, and the second axis may be an axis connecting the third side surface and the fourth side surface to each other while passing through the optical axis. The first axis and the second axis are perpendicular to each other, and a length of the first axis may be greater than a length of the second axis.

For example, the first lens may have the two axes, perpendicular to each other. One of the two axes may have a length greater than a length of the other axis.

All of the lenses of the optical imaging system may include an optical portion 10 and a flange portion 30.

The optical portion 10 may be a portion exhibiting optical performance of the lens. For example, light reflected from a subject may be refracted while passing through the optical portion 10.

The optical portion 10 may have a refractive power and may have an aspherical shape.

In addition, the optical portion 10 may have an object-side surface (a surface facing the object side) and an image-side surface (a surface facing the imaging plane) (the object-side surface is illustrated in FIG. 18).

The flange portion 30 may be a portion fixing a lens to another component, for example, a lens barrel or another lens.

The flange portion 30 extends around at least a portion of the optical portion 10, and may be formed to be integrated with the optical portion 10.

In the lens having a non-circular planar shape, the optical portion 10 and the flange portion 30 may be formed to have a non-circular shape. For example, the optical portion 10 and the flange portion 30 may be non-circular when viewed in the optical axis direction (see FIG. 18). Alternatively, the optical portion 10 may be formed to a circular shape and the flange portion 30 may be formed to have a non-circular shape.

The optical portion 10 may have a first edge 11, a second edge 12, a third edge 13, and a fourth edge 14. The first edge 11 and the second edge 12 may be disposed to face each other, and the third edge 13 and the fourth edge 14 may be disposed to face each other.

Each of the third edge 13 and the fourth edge 14 may connect the first edge 11 and the second edge 12 to each other.

The first edge 11 and the second edge 12 may be disposed on opposite sides with respect to the optical axis, and the third edge 13 and the fourth edge 14 may be disposed on opposite sides with respect to the optical axis.

When viewed in the optical axis direction, each of the first edge 11 and the second edge 12 may have an arc shape, and each of the third edge 13 and the fourth edge 14 may have a substantially linear shape. The third edge 13 and the fourth edge 14 may be symmetrical with respect to an optical axis (a Z-axis), and may be parallel to each other.

A shortest distance between the first edge 11 and the second edge 12 may be greater than a shortest distance between the third edge 13 and the fourth edge 14.

The optical portion 10 may have a major axis “a,” and a minor axis “b.” For example, when viewed in the optical axis direction, a line segment connecting the third edge 13 and the fourth edge 14 at the shortest distance while passing through the optical axis may be the minor axis “b,” and a line segment connecting the first edge 11 and the second edge 12 while passing through the optical axis and perpendicular to the minor axis “b” may be the major axis “a.”

In this case, half of the major axis “a” may be a maximum effective radius, and half of the minor axis “b” may be a minimum effective radius.

Assuming that the lens illustrated in FIG. 18 is a forwardmost lens (for example, the first lens), a maximum effective radius of an object-side surface of the forwardmost lens may be denoted by a reference numeral L1S1el of FIG. 18, and a minimum effective radius of the object-side surface of the forwardmost lens may be denoted by a reference numeral L1S1es of FIG. 18.

The flange portion 30 may include a first flange portion 31 and a second flange portion 32. The first flange portion 31 may extend from the first edge 11 of the optical portion 10, and the second flange portion 32 may extend from the second edge 12 of the optical portion 10.

The first edge 11 of the optical portion 10 may refer to a portion adjacent to the first flange portion 31, and the second edge 12 of the optical portion 10 may refer to a portion adjacent to the second flange portion 32.

The third edge 13 of the optical portion 10 may refer to one side surface of the optical portion 10 on which the flange portion 30 is not formed, and the fourth edge 14 of the optical portion 10 may refer to the other side surface of the optical portion 10 on which the flange portion 30 is not formed.

Effective radii of the first lens and the second lens may be greater than those of the other lenses of the optical imaging system.

The effective radius refers to a radius of one surface (an object-side surface or an image-side surface) of each lens through which light actually passes. For example, the effective radius may refer to a radius of an optical portion of each lens.

A non-circular lens may have a maximum effective radius (half of a shortest straight line connecting the first edge 11 and the second edge 12 to each other while passing through the optical axis) and a minimum effective radius (half of a shortest straight line connecting the third edge 13 and the fourth edge 14 to each other while passing through the optical axis).

In the present disclosure, the term “effective radius” may refer to a maximum effective radius unless otherwise specified.

Each of the plurality of lenses may have at least one aspherical surface.

For example, at least one of the first surface and the second surface of each lens may be aspherical. Each aspherical surface is defined by Equation 1 below.

$$Z = \frac{c {Y}^{2}}{1 + \sqrt{1 - ( 1 + K ) {c}^{2} {Y}^{2}}} + A {Y}^{4} + {BY}^{6} + {CY}^{8} + {DY}^{10} + {EY}^{12} + {FY}^{14} + {GY}^{16} + {HY}^{18} + {JY}^{20} + {LY}^{22} + {MY}^{24} + {NY}^{26} + {OY}^{28} + {PY}^{30} … \qquad Equation 1$$

In Equation 1, c is a curvature (an inverse of a radius of curvature) of a lens, K is a conic constant, and Y is a distance from a certain point on an aspherical surface of the lens to an optical axis of the lens in a direction, perpendicular to the optical axis. In addition, constants A to H, J, and L to P are aspherical coefficients. In addition, Z is a distance from the certain point on the aspherical surface of the lens to a tangential plane meeting the apex of the aspherical surface of the lens.

The optical imaging system according to an example may satisfy at least one of Conditional Expressions 1 to 16 below.

2.0<f/(2×L1S1el)<2.7 Conditional Expression 1

1.7 mm<D2<3.5 mm Conditional Expression 2

2.0<f/(2×IMG HT)<3.0 Conditional Expression 3

L1S1el/L1S1es<1.0 Conditional Expression 4

4.5<n2+n3+n4<5.0 Conditional Expression 5

0.8<TTL/f<1.2 Conditional Expression 6

0.9<f1/(2×L1S1el)<2.0 Conditional Expression 7

0.9<f12/f<2.5 Conditional Expression 8

7.0<f12/D2<17.0 Conditional Expression 9

0.16<D2/|f2|<0.3 Conditional Expression 10

0.6<|f1|/|f2|<1.0 Conditional Expression 11

0.7<BFL/(2×IMG HT)<1.5 Conditional Expression 12

0.3<BFL/TTL<0.6 Conditional Expression 13

0.4<TD/TTL<0.7 Conditional Expression 14

1.0<L1S1el/L2S1el<1.2 Conditional Expression 15

1.5<L1S1el/Min_el<0.7 Conditional Expression 16

In the conditional expressions, f is an overall focal length of the optical imaging system, f1 is a focal length of the first lens, f2 is a focal length of the second lens, and f12 is a synthetic focal length of the first lens and the second lens.

n2 is a refractive index of the second lens, and n3 is a refractive index of the third lens.

TTL is a distance along the optical axis from the object-side surface of the first lens to an imaging plane of the image sensor, and BFL is a distance along the optical axis from the image-side surface of the fifth lens to the imaging plane of the image sensor.

D2 is a distance along the optical axis between an image-side surface of the second lens and an object-side surface of the third lens, and IMG HT is half of a diagonal length of the imaging plane.

L1S1el is a maximum effective radius of the object-side surface of the first lens, L1S1es is a minimum effective radius of the object-side surface of the first lens, L2S1el is a maximum effective radius of the object-side surface of the second lens, and Min_el is a smallest value, among the effective radii of the object-side surfaces of the third to fifth lenses.

The optical imaging system according to an example may have characteristics of a telephoto lens having a relatively narrow field of view and a large focal length.

In addition, the optical imaging system according to an example may be configured to have a relatively large diagonal length of the imaging plane. For example, an effective capturing area of the image sensor may be wide (for example, a high-pixel image sensor).

Accordingly, when a captured image is cropped, images corresponding to various magnifications may be captured without degradation of image quality.

Each of the second to fourth lenses may be configured to have a refractive index, greater than a refractive index of each of the first and fifth lenses.

For example, a smallest value among the refractive indices of the second to fourth lenses may be greater than a largest value among the refractive indices of the first lens and the fifth lens.

In an example, each of the second lens and the fourth lens may have a refractive index of 1.64 or more.

In an example, among the first to fifth lenses, the third lens may be configured to have a largest refractive index. In this case, the refractive index of the third lens may be 1.66 or more.

In an example, among the first to fifth lenses, the fourth lens may be configured to have a largest refractive index. In this case, the refractive index of the fourth lens may be 1.66 or more.

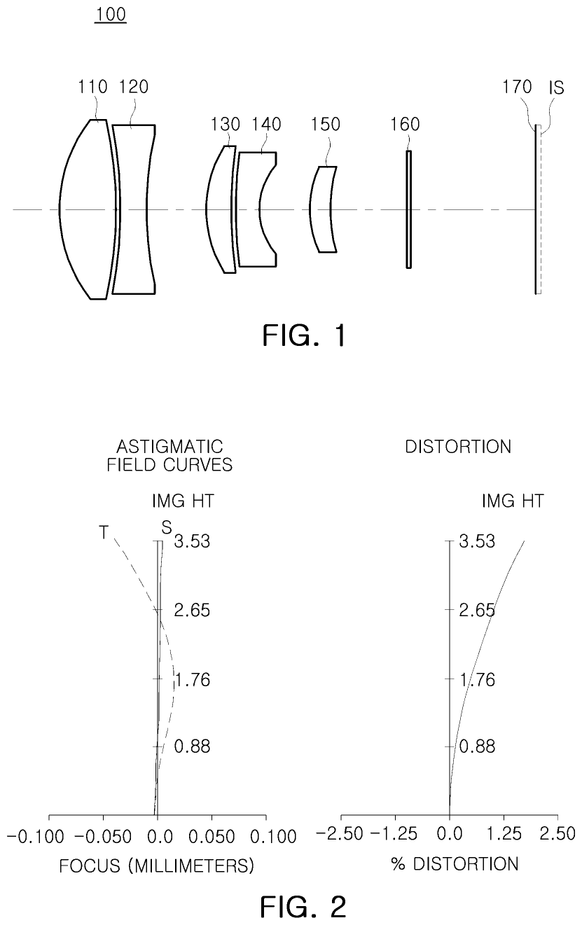

An optical imaging system according to a first example will be described with reference to FIGS. 1 and 2.

An optical imaging system 100 according to the first example may include a first lens 110, a second lens 120, a third lens 130, a fourth lens 140, and a fifth lens 150, and may further include a filter 160 and an image sensor IS.

The optical imaging system 100 according to the first example may form a focus on an imaging plane 170. The imaging plane 170 may refer to a surface on which a focus is formed by an optical imaging system. As an example, the imaging plane 170 may refer to one surface of the image sensor IS on which light is received.

Although not illustrated in FIG. 1, the optical imaging system may further include a reflective member R disposed in front of the first lens 110 and having a reflective surface changing an optical path. In the first example, the reflective member R may be a prism, but may also be provided as a mirror.

Lens characteristics (a radius of curvature, a thickness of a lens or a distance between lenses, a refractive index, Abbe number, a focal length, and the like) of each lens are listed in Table 1.

TABLE 1

| | | | | | | | | Minor |
|---|---|---|---|---|---|---|---|---|
| Surface | | Radius of | Thickness | Refractive | Abbe | Focal | Major Axis | Axis Effective |
| No. | Remark | Curvature | or Distance | Index | Number | Length | Effective Radius | Radius |
| S1 | First Lens | 6.388 | 2.200 | 1.537 | 55.7 | 8.5052 | 3.75 | 2.7 |
| S2 | | −14.063 | 0.153 | | | | 3.598 | 2.7 |
| S3 | Second | −16.443 | 1.000 | 1.644 | 23.5 | −10.962 | 3.513 | 2.7 |
| | Lens | | | | | | | |
| S4 | | 12.666 | 2.377 | | | | 3.174 | 2.7 |
| S5 | Third | 5.324 | 0.994 | 1.677 | 19.2 | 8.97152 | 2.632 | |
| | Lens | | | | | | | |
| S6 | | 39.910 | 0.158 | | | | 2.474 | |
| S7 | Fourth | 12.132 | 0.911 | 1.644 | 23.5 | −5.7495 | 2.375 | |
| | Lens | | | | | | | |
| S8 | | 2.754 | 2.000 | | | | 1.909 | |
| S9 | Fifth Lens | 4.797 | 0.800 | 1.546 | 56.0 | 23.3403 | 1.75 | |
| S10 | | 7.241 | 3.000 | | | | 1.799 | |
| S11 | Filter | Infinity | 0.110 | 1.518 | 64.2 | | 2.534 | |
| S12 | | Infinity | 4.894 | | | | 2.553 | |
| S13 | Imaging | Infinity | | | | | | |
| | Plane | | | | | | | |

An overall focal length f of the optical imaging system according to the first example is 19 mm, 2×IMG HT is 7.06 mm, and f12 is 23.476 mm.

In the first example, the first lens 110 may have a positive refractive power, and a first surface and a second surface of the first lens 110 may be convex.

The second lens 120 may have a negative refractive power, and a first surface and a second surface of the second lens 120 may be concave.

The third lens 130 may have a positive refractive power, a first surface of the third lens 130 may be convex, and a second surface of the third lens 130 may be concave.

The fourth lens 140 may have a negative refractive power, a first surface of the fourth lens 140 may be convex, and a second surface of the fourth lens 140 may be concave.

The fifth lens 150 may have a positive refractive power, a first surface of the fifth lens 150 may be convex, and a second surface of the fifth lens 150 may be concave.

Each surface of the first lens 110 to the fifth lens 150 may have an aspherical coefficient, as listed in Table 2. For example, both object-side surfaces and image-side surfaces of the first lens 110 to the fifth lens 150 may be aspherical.

TABLE 2

| | S1 | S2 | S3 | S4 | S5 |
|---|---|---|---|---|---|
| Conic Constant(K) | −0.565 | −22.284 | −44.910 | −3.385 | −0.936 |
| 4th Coefficient(A) | 1.2837E−04 | 7.2972E−05 | −7.7249E−04 | −7.5043E−04 | −2.8228E−04 |
| 6th Coefficient(B) | 1.1775E−05 | 1.1858E−05 | 5.5166E−05 | 3.3038E−05 | 9.8550E−05 |
| 8th Coefficient(C) | −1.6360E−07 | −3.8990E−07 | −1.2326E−06 | 1.8677E−06 | 5.9798E−06 |
| 10th Coefficient(D) | 2.1922E−08 | −1.3903E−08 | 2.6904E−08 | 2.2761E−08 | −1.7111E−07 |
| 12th Coefficient(E) | −1.9394E−09 | 2.0204E−12 | −1.7658E−09 | −1.1622E−08 | 3.0591E−08 |
| 14th Coefficient(F) | 1.9942E−12 | −1.5264E−12 | −2.0530E−12 | 4.3719E−12 | 2.1797E−08 |
| 16th Coefficient(G) | 1.7783E−13 | | | −7.6957E−13 | −2.3398E−10 |
| 18th Coefficient(H) | | | | | |
| 20th Coefficient(J) | | | | | |
| 22nd Coefficient(L) | | | | | |
| 24th Coefficient(M) | | | | | |
| 26th Coefficient(N) | | | | | |
| 28th Coefficient(O) | | | | | |
| 30th Coefficient(P) | | | | | |
| | S6 | S7 | S8 | S9 | S10 |
| Conic Constant(K) | 99.000 | −59.926 | −0.337 | −0.852 | −2.477 |
| 4th Coefficient(A) | 5.0314E−04 | −4.3354E−04 | −8.3265E−03 | −1.8580E−03 | −9.1676E−04 |
| 6th Coefficient(B) | 4.4107E−06 | 2.5943E−05 | −1.0745E−02 | 3.7205E−04 | 1.1513E−04 |
| 8th Coefficient(C) | 2.5859E−06 | 7.7176E−06 | 5.8006E−02 | 4.3679E−06 | 6.5597E−05 |
| 10th Coefficient(D) | 1.1422E−06 | −4.2431E−07 | −1.5586E−01 | 6.0206E−06 | −9.2559E−06 |
| 12th Coefficient(E) | 1.3583E−07 | −1.2106E−07 | 2.6406E−01 | −1.3084E−07 | 1.7086E−06 |
| 14th Coefficient(F) | 4.5809E−09 | −1.4328E−08 | −3.0218E−01 | 4.1174E−17 | 6.5639E−17 |
| 16th Coefficient(G) | −9.3871E−10 | −8.6388E−10 | 2.4257E−01 | | |
| 18th Coefficient(H) | | 2.8885E−10 | −1.3929E−01 | | |
| 20th Coefficient(J) | | | 5.7553E−02 | | |
| 22nd Coefficient(L) | | | −1.6980E−02 | | |
| 24th Coefficient(M) | | | 3.4909E−03 | | |
| 26th Coefficient(N) | | | −4.7513E−04 | | |
| 28th Coefficient(O) | | | 3.8479E−05 | | |
| 30th Coefficient(P) | | | −1.4039E−06 | | |

The above-configured optical system may have aberration characteristics illustrated in FIG. 2.

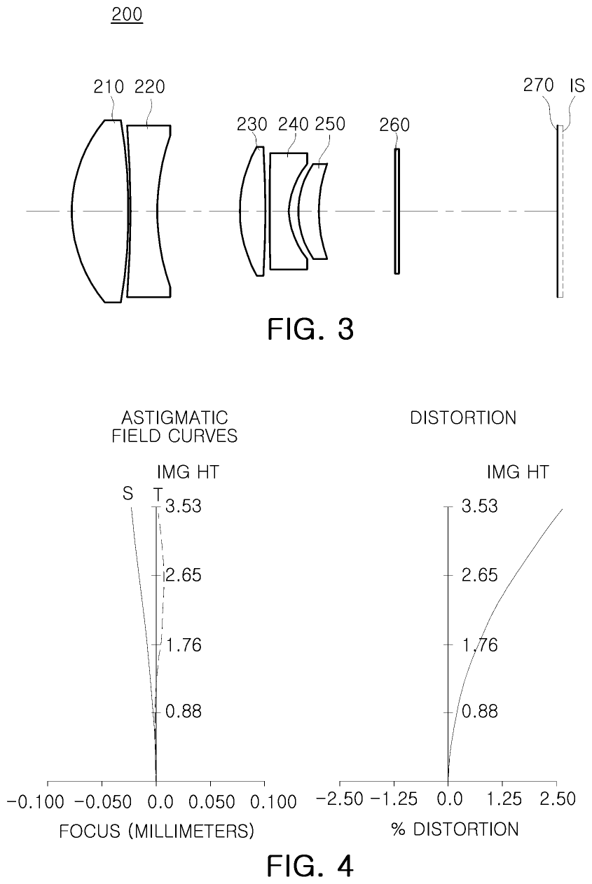

An optical imaging system according to a second example will be described with reference to FIGS. 3 and 4.

An optical imaging system 200 according to the second example may include a first lens 210, a second lens 220, a third lens 230, a fourth lens 240, and a fifth lens 250, and may further include a filter 260 and an image sensor IS.

The optical imaging system 200 according to the second example may form a focus on an imaging plane 270. The imaging plane 270 may refer to a surface on which a focus is formed by an optical imaging system. As an example, the imaging plane 270 may refer to one surface of the image sensor IS on which light is received.

Although not illustrated in FIG. 3, the optical imaging system may further include a reflective member R disposed in front of the first lens 210 and having a reflective surface changing an optical path. In the second example, the reflective member R may be a prism, but may also be provided as a mirror.

Lens characteristics (a radius of curvature, a thickness of a lens or a distance between lenses, a refractive index, Abbe number, a focal length, and the like) of each lens are listed in Table 3.

TABLE 3

| | | | | | | | Major Axis | Minor Axis |
|---|---|---|---|---|---|---|---|---|
| Surface | | Radius of | Thickness or | Refractive | Abbe | Focal | Effective | Effective |
| No. | Remark | Curvature | Distance | Index | Number | Length | Radius | Radius |
| S1 | First | 6.202 | 2.195 | 1.537 | 55.7 | 9.3552 | 3.75 | 2.7 |
| | Lens | | | | | | | |
| S2 | | −23.088 | 0.100 | | | | 3.582 | 2.7 |
| S3 | Second | −52.207 | 1.000 | 1.644 | 23.5 | −11.378 | 3.503 | 2.7 |
| | Lens | | | | | | | |
| S4 | | 8.588 | 3.206 | | | | 3.139 | 2.7 |
| S5 | Third | 5.839 | 1.000 | 1.677 | 19.2 | 6.7556 | 2.593 | |
| | Lens | | | | | | | |
| S6 | | −19.642 | 0.150 | | | | 2.497 | |
| S7 | Fourth | 95.919 | 0.724 | 1.644 | 23.5 | −4.2693 | 2.372 | |
| | Lens | | | | | | | |
| S8 | | 2.665 | 0.367 | | | | 1.964 | |
| S9 | Fifth | 3.161 | 0.800 | 1.546 | 56.0 | 13.0411 | 1.95 | |
| | Lens | | | | | | | |
| S10 | | 5.177 | 3.000 | | | | 1.953 | |
| S11 | Filter | Infinity | 0.110 | 1.518 | 64.2 | | 2.524 | |
| S12 | | Infinity | 6.107 | | | | 2.540 | |
| S13 | Imaging | Infinity | | | | | | |
| | Plane | | | | | | | |

An overall focal length f of the optical imaging system according to the second example is 19 mm, 2×IMG HT is 7.06 mm, and f12 is 28.027 mm.

In the second example, the first lens 210 may have a positive refractive power, and first and second surfaces of the first lens 210 may be convex.

The second lens 220 may have a negative refractive power, and first and second surfaces of the second lens 220 may be concave.

The third lens 230 may have a positive refractive power, and first and second surfaces of the third lens 230 may be convex.

The fourth lens 240 may have a negative refractive power, a first surface of the fourth lens 240 may be convex, and a second surface of the fourth lens 240 may be concave.

The fifth lens 250 may have a positive refractive power, a first surface of the fifth lens 250 may be convex, and a second surface of the fifth lens 250 may be concave.

Each surface of the first lens 210 to the fifth lens 250 may have an aspherical coefficient, as listed in Table 4. For example, both object-side surfaces and image-side surfaces of the first lens 210 to the fifth lens 250 may be aspherical.

TABLE 4

| | S1 | S2 | S3 | S4 | S5 |
|---|---|---|---|---|---|
| Conic Constant(K) | −0.583 | −14.493 | −17.589 | −2.108 | −1.145 |
| 4th Coefficient(A) | 2.0301E−04 | 1.3029E−04 | −7.5074E−04 | −6.7687E−04 | −3.6155E−04 |
| 6th Coefficient(B) | 2.7951E−06 | 1.6309E−05 | 5.8466E−05 | 2.9980E−05 | 1.2388E−04 |
| 8th Coefficient(C) | 1.0812E−07 | −4.1264E−07 | −1.1118E−06 | 1.0152E−06 | 9.2546E−07 |
| 10th Coefficient(D) | 1.8839E−08 | −4.1192E−08 | 1.0494E−08 | 1.6242E−08 | −2.7561E−07 |
| 12th Coefficient(E) | −2.9976E−09 | | −1.8970E−09 | −1.1437E−08 | 3.8515E−08 |
| 14th Coefficient(F) | | | | | 1.8933E−08 |
| 16th Coefficient(G) | | | | | −7.4731E−10 |
| 18th Coefficient(H) | | | | | |
| 20th Coefficient(J) | | | | | |
| 22nd Coefficient(L) | | | | | |
| 24th Coefficient(M) | | | | | |
| 26th Coefficient(N) | | | | | |
| 28th Coefficient(O) | | | | | |
| 30th Coefficient(P) | | | | | |
| | S6 | S7 | S8 | S9 | S10 |
| Conic Constant(K) | −79.626 | −53.239 | −0.398 | −0.772 | 4.202 |
| 4th Coefficient(A) | 1.2688E−03 | −5.8130E−06 | −6.4395E−03 | −2.2797E−03 | −5.5483E−03 |
| 6th Coefficient(B) | −6.5968E−06 | −3.2146E−06 | −4.4962E−03 | −1.3553E−03 | 1.5155E−03 |
| 8th Coefficient(C) | 2.7910E−06 | −1.0300E−06 | 1.6660E−02 | −1.7887E−03 | −1.2545E−02 |
| 10th Coefficient(D) | 6.6337E−07 | −2.4469E−07 | −4.1238E−02 | 8.2683E−03 | 3.3706E−02 |
| 12th Coefficient(E) | −2.3681E−09 | −2.5055E−08 | 7.0713E−02 | −1.1334E−02 | −5.7117E−02 |
| 14th Coefficient(F) | | −3.6719E−09 | −8.4605E−02 | 6.1491E−03 | 6.5800E−02 |
| 16th Coefficient(G) | | −4.0976E−10 | 7.1632E−02 | 2.0007E−03 | −5.3301E−02 |
| 18th Coefficient(H) | | −6.8742E−23 | −4.3346E−02 | −5.5646E−03 | 3.0799E−02 |
| 20th Coefficient(J) | | 2.2059E−24 | 1.8769E−02 | 4.1875E−03 | −1.2733E−02 |
| 22nd Coefficient(L) | | | −5.7581E−03 | −1.7844E−03 | 3.7338E−03 |
| 24th Coefficient(M) | | | 1.2200E−03 | 4.7373E−04 | −7.5795E−04 |
| 26th Coefficient(N) | | | −1.6956E−04 | −7.7785E−05 | 1.0124E−04 |
| 28th Coefficient(O) | | | 1.3896E−05 | 7.2550E−06 | −8.0024E−06 |
| 30th Coefficient(P) | | | −5.0867E−07 | −2.9463E−07 | 2.8355E−07 |

The above-configured optical system may have aberration characteristics illustrated in FIG. 4.

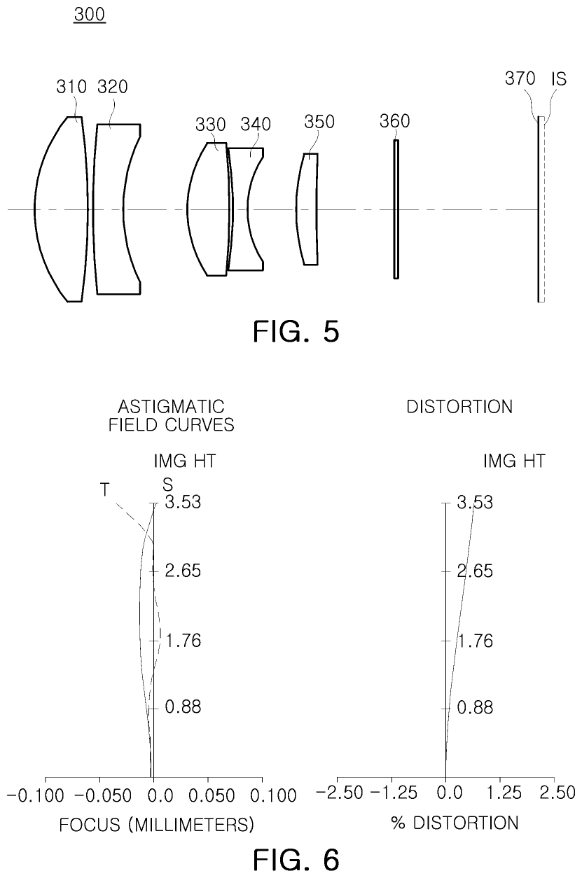

An optical imaging system according to a third example will be described with reference to FIGS. 5 and 6.

An optical imaging system 300 according to the third example may include a first lens 310, a second lens 320, a third lens 330, a fourth lens 340, and a fifth lens 350, and may further include a filter 360 and an image sensor IS.

The optical imaging system according to the third exemplary example may form a focus on the imaging plane 370. The imaging plane 370 may refer to a surface on which a focus is formed by an optical imaging system. For example, the imaging plane 370 may refer to one surface of the image sensor IS on which light is received.

Although not illustrated in FIG. 5, the optical imaging system may further include a reflective member R disposed in front of the first lens 310 and having a reflective surface changing an optical path. In the third example, the reflective member R may be a prism, but may also be provided as a mirror.

Lens characteristics (a radius of curvature, a thickness of a lens or a distance between lenses, a refractive index, Abbe number, a focal length, and the like) of each lens are listed in Table 5.

TABLE 5

| | | | | | | | Major Axis | Minor Axis |
|---|---|---|---|---|---|---|---|---|
| Surface | | Radius of | Thickness or | Refractive | Abbe | Focal | Effective | Effective |
| No. | Remark | Curvature | Distance | Index | Number | Length | Radius | Radius |
| S1 | First | 6.221 | 2.000 | 1.537 | 55.7 | 9.3057 | 3.8 | 2.7 |
| | Lens | | | | | | | |
| S2 | | −22.584 | 0.272 | | | | 3.692 | 2.7 |
| S3 | Second | 51.739 | 1.108 | 1.646 | 23.5 | −10.471 | 3.485 | 2.7 |
| | Lens | | | | | | | |
| S4 | | 5.928 | 2.500 | | | | 3.086 | 2.7 |
| S5 | Third | 5.169 | 1.626 | 1.668 | 20.4 | 6.2416 | 2.776 | |
| | Lens | | | | | | | |
| S6 | | −18.893 | 0.115 | | | | 2.556 | |
| S7 | Fourth | −11.431 | 0.518 | 1.646 | 23.5 | −4.3086 | 2.555 | |
| | Lens | | | | | | | |
| S8 | | 3.741 | 1.911 | | | | 2.222 | |
| S9 | Fifth | 5.723 | 0.800 | 1.546 | 56.0 | 15.7952 | 2.2 | |
| | Lens | | | | | | | |
| S10 | | 16.154 | 3.000 | | | | 2.295 | |
| S11 | Filter | Infinity | 0.110 | 1.518 | 64.2 | | 2.842 | |
| S12 | | Infinity | 5.422 | | | | 2.855 | |
| S13 | Imaging | Infinity | | | | | | |
| | Plane | | | | | | | |

An overall focal length f of the optical imaging system according to the third example is 19 mm, 2×IMG HT is 7.06 mm, and f12 is 29.97 mm.

In the third example, the first lens 310 may have a positive refractive power, and first and second surfaces of the first lens 310 may be convex.

The second lens 320 may have a negative refractive power, a first surface of the second lens 320 may be convex, and a second surface of the second lens 320 may be concave.

The third lens 330 may have a positive refractive power, and first and second surfaces of the third lens 330 may be convex.

The fourth lens 340 may have a negative refractive power, and first and second surfaces of the fourth lens 340 may be concave.

The fifth lens 350 may have a positive refractive power, a first surface of the fifth lens 350 may be convex, and a second surface of the fifth lens 350 may be concave.

Each surface of the first lens 310 to the fifth lens 350 may have an aspherical coefficient, as listed in Table 6. For example, both object-side surfaces and image-side surfaces of the first lens 310 to the fifth lens 350 may be aspherical.

TABLE 6

| | S1 | S2 | S3 | S4 | S5 |
|---|---|---|---|---|---|
| Conic Constant(K) | −0.781 | −55.384 | 89.093 | 0.035 | 0.134 |
| 4th Coefficient(A) | 1.6007E−04 | 6.4000E−05 | −1.0648E−03 | −2.6005E−03 | −1.9859E−03 |
| 6th Coefficient(B) | −3.8737E−07 | 2.2961E−07 | 7.3000E−05 | 9.6000E−05 | 7.0000E−05 |
| 8th Coefficient(C) | 4.9375E−08 | 1.1731E−07 | −1.0000E−06 | −3.0000E−06 | −1.0000E−05 |
| 10th Coefficient(D) | −1.9560E−08 | 1.2231E−08 | 2.6311E−10 | 4.9934E−07 | 3.0000E−06 |
| 12th Coefficient(E) | −2.9549E−09 | 3.7294E−11 | −5.1067E−09 | −5.9284E−08 | 1.0815E−07 |
| 14th Coefficient(F) | 2.5129E−10 | −4.8113E−11 | 1.4487E−10 | −9.0134E−09 | −1.3629E−08 |
| 16th Coefficient(G) | 5.5139E−12 | −4.7541E−12 | 1.6260E−11 | 1.5813E−09 | −2.1511E−09 |
| 18th Coefficient(H) | −3.1887E−13 | −2.9947E−13 | −4.1767E−12 | −8.8132E−11 | −8.6230E−10 |
| 20th Coefficient(J) | −2.5505E−14 | 1.8928E−14 | 2.3953E−13 | 2.5032E−12 | 1.1011E−10 |
| | S6 | S7 | S8 | S9 | S10 |
| Conic Constant(K) | −49.033 | −2.889 | −0.071 | −0.258 | 39.477 |
| 4th Coefficient(A) | −1.5122E−03 | 2.1355E−04 | −4.4021E−03 | −5.0551E−03 | −4.3883E−03 |
| 6th Coefficient(B) | 3.0970E−04 | 3.3000E−05 | 2.0541E−04 | −4.0297E−04 | −4.5389E−04 |
| 8th Coefficient(C) | −1.7000E−05 | 6.0000E−06 | −6.2000E−05 | 8.8000E−05 | −2.3640E−05 |
| 10th Coefficient(D) | 4.0000E−06 | 1.0000E−06 | 1.3000E−05 | −2.7000E−05 | 5.6783E−06 |
| 12th Coefficient(E) | 1.6556E−07 | 3.4980E−08 | −1.0000E−06 | 1.0000E−06 | −9.5464E−07 |
| 14th Coefficient(F) | −5.9170E−08 | −6.5170E−09 | 3.9381E−07 | 1.0000E−06 | −4.1635E−07 |
| 16th Coefficient(G) | −1.1099E−08 | −1.1190E−09 | −4.3922E−08 | −5.3364E−08 | 6.8765E−08 |
| 18th Coefficient(H) | −2.6547E−10 | | −7.1429E−09 | −1.1038E−08 | 9.4030E−09 |
| 20th Coefficient(J) | 2.2903E−10 | | 1.1927E−09 | 1.2553E−09 | −1.8879E−09 |

The above-configured optical system may have aberration characteristics as illustrated in FIG. 6.

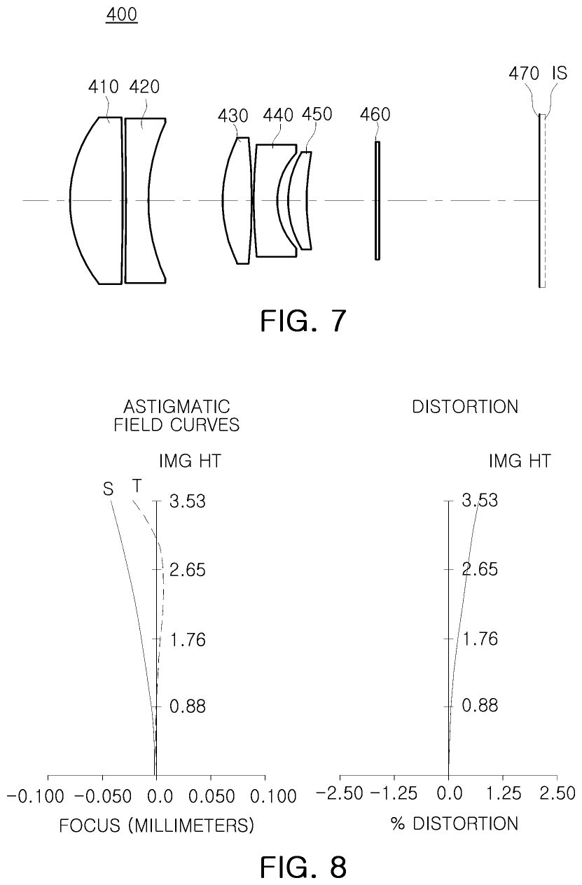

An optical imaging system according to a fourth example will be described with reference to FIGS. 7 and 8.

An optical imaging system 400 according to the fourth example may include a first lens 410, a second lens 420, a third lens 430, a fourth lens 440, and a fifth lens 450, and may further include a filter 460 and an image sensor IS.

The optical imaging system according to the fourth example may form a focal point on the imaging plane 470. The imaging plane 470 may refer to a plane on which a focus is formed by the optical imaging system. For example, the imaging plane 470 may refer to one surface of the image sensor IS on which light is received.

Although not illustrated in FIG. 7, the optical imaging system may further include a reflective member R disposed in front of the first lens 410 and having a reflective surface changing an optical path. In the fourth example, the reflective member R may be a prism, but may also be provided as a mirror.

Lens characteristics (a radius of curvature, a thickness of a lens or a distance between lenses, a refractive index, Abbe number, a focal length, and the like) of each lens are listed in Table 7.

TABLE 7

| | | | | | | | Major Axis | Minor Axis |
|---|---|---|---|---|---|---|---|---|
| Surface | | Radius of | Thickness or | Refractive | Abbe | Focal | Effective | Effective |
| No. | Remark | Curvature | Distance | Index | Number | Length | Radius | Radius |
| S1 | First | 6.205 | 2.300 | 1.537 | 55.7 | 11.623 | 3.8 | 2.7 |
| | Lens | | | | | | | |
| S2 | | 1048.652 | 0.100 | | | | 3.692 | 2.7 |
| S3 | Second | 137.578 | 0.960 | 1.644 | 23.5 | −12.524 | 3.485 | 2.7 |
| | Lens | | | | | | | |
| S4 | | 7.598 | 3.177 | | | | 3.086 | 2.7 |
| S5 | Third | 7.108 | 1.256 | 1.667 | 20.4 | 8.182 | 2.776 | |
| | Lens | | | | | | | |
| S6 | | −21.779 | 0.100 | | | | 2.556 | |
| S7 | Fourth | 12.557 | 1.000 | 1.644 | 23.5 | −5.258 | 2.555 | |
| | Lens | | | | | | | |
| S8 | | 2.584 | 0.480 | | | | 2.222 | |
| S9 | Fifth | 3.445 | 0.769 | 1.546 | 56.0 | 11.468 | 2.2 | |
| | Lens | | | | | | | |
| S10 | | 7.058 | 3.000 | | | | 2.295 | |
| S11 | Filter | Infinity | 0.110 | 1.518 | 64.2 | | 2.842 | |
| S12 | | Infinity | 6.909 | | | | 2.855 | |
| S13 | Imaging | Infinity | | | | | | |
| | Plane | | | | | | | |

An overall focal length f of the optical imaging system according to the fourth example is 19 mm, 2×IMG HT is 7.06 mm, and f12 is 46.582 mm.

In the fourth example, the first lens 410 may have a positive refractive power, a first surface of the first lens 410 may be convex, and a second surface of the first lens 410 may be concave.

The second lens 420 may have a negative refractive power, a first surface of the second lens 420 may be convex, and a second surface of the second lens 420 may be concave.

The third lens 430 may have a positive refractive power, and first and second surfaces of the third lens 430 may be convex.

The fourth lens 440 may have a negative refractive power, a first surface of the fourth lens 440 may be convex, and a second surface of the fourth lens 440 may be concave.

The fifth lens 450 may have a positive refractive power, a first surface of the fifth lens 450 may be convex, and a second surface of the fifth lens 450 may be concave.

Each surface of the first lens 410 to the fifth lens 450 may have an aspherical coefficient, as listed in Table 8. For example, both object-side surfaces and image-side surfaces of the first lens 410 to the fifth lens 450 may be aspherical.

TABLE 8

| | S1 | S2 | S3 | S4 | S5 |
|---|---|---|---|---|---|
| Conic Constant(K) | −0.608 | −99.000 | −17.650 | −1.620 | −1.109 |
| 4th Coefficient(A) | 2.0560E−04 | 1.0000E−05 | −8.9824E−04 | −7.2021E−04 | −4.3234E−04 |
| 6th Coefficient(B) | −1.0000E−06 | 8.0000E−06 | 5.7000E−05 | 2.9000E−05 | 1.3765E−04 |
| 8th Coefficient(C) | 2.9688E−08 | −1.0000E−06 | −1.0000E−06 | 1.0000E−06 | 2.0000E−06 |
| 10th Coefficient(D) | 1.5127E−08 | −4.5158E−08 | 3.5899E−09 | −9.6431E−08 | −3.6858E−07 |
| 12th Coefficient(E) | −3.2768E−09 | −1.4913E−09 | −1.2025E−09 | −1.7510E−08 | −1.7722E−08 |
| 14th Coefficient(F) | | 5.4992E−11 | | 6.9746E−10 | 5.9832E−09 |
| 16th Coefficient(G) | | | | | −4.4108E−10 |
| 18th Coefficient(H) | | | | | |
| 20th Coefficient(J) | | | | | |
| | S6 | S7 | S8 | S9 | S10 |
| Conic Constant(K) | 0.000 | −14.735 | −0.574 | −1.086 | 6.456 |
| 4th Coefficient(A) | 1.2040E−03 | −1.7781E−03 | −8.9175E−03 | −5.7312E−03 | −7.3192E−03 |
| 6th Coefficient(B) | −2.1000E−05 | −6.6000E−05 | 5.9996E−04 | −1.3809E−04 | −1.5482E−03 |
| 8th Coefficient(C) | −1.0000E−06 | −1.2000E−05 | −4.5000E−05 | 2.9555E−04 | 1.2452E−03 |
| 10th Coefficient(D) | 3.4911E−07 | 1.7623E−07 | 4.0000E−06 | 3.5000E−05 | −6.5252E−04 |
| 12th Coefficient(E) | −6.7380E−08 | 3.1284E−08 | −2.0000E−06 | −1.1261E−04 | 1.8872E−04 |
| 14th Coefficient(F) | 1.5971E−09 | −5.1144E−09 | 2.1033E−07 | 5.7000E−05 | −2.5544E−05 |
| 16th Coefficient(G) | | 9.1872E−10 | −4.2323E−08 | −1.4000E−05 | −5.0111E−07 |
| 18th Coefficient(H) | | 1.8532E−11 | −2.6924E−09 | 2.0000E−06 | 5.0487E−07 |
| 20th Coefficient(J) | | −4.5634E−12 | 9.5778E−10 | −8.3872E−08 | −3.8791E−08 |

The above-configured optical system may have aberration characteristics illustrated in FIG. 8.

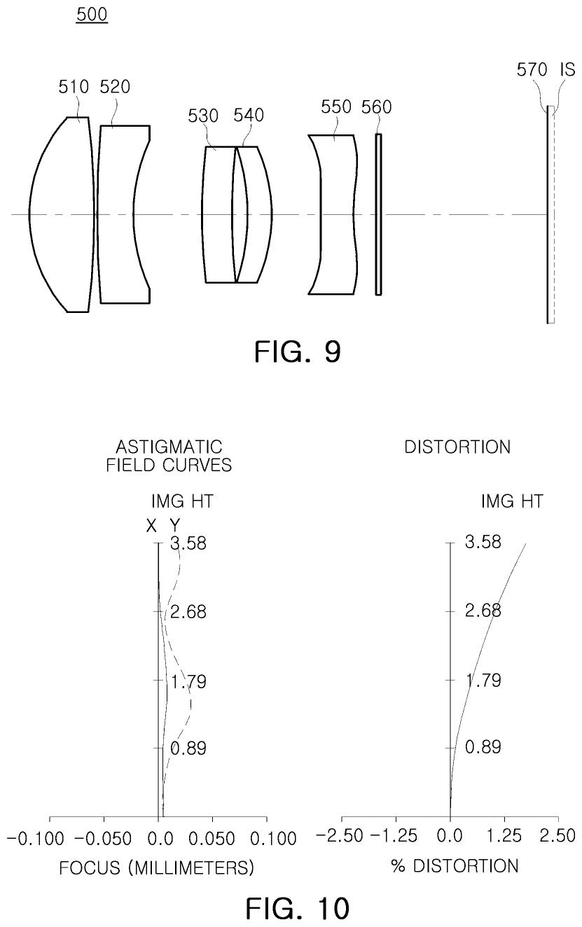

An optical imaging system according to a fifth example will be described with reference to FIGS. 9 and 10.

An optical imaging system 500 according to the fifth example may include a first lens 510, a second lens 520, a third lens 530, a fourth lens 540, and a fifth lens 550, and may further include a filter 560 and an image sensor IS.

The optical imaging system according to the fifth example may form a focus on the imaging plane 570. The imaging plane 570 may refer to a surface on which a focus is formed by an optical imaging system. For example, the imaging plane 570 may refer to one surface of the image sensor IS on which light is received.

Although not illustrated in FIG. 9, the optical imaging system may further include a reflective member R disposed in front of the first lens 510 and having a reflective surface changing an optical path. In the fifth example, the reflective member R may be a prism, but may also be provided as a mirror.

Lens characteristics (a radius of curvature, a thickness of a lens or a distance between lenses, a refractive index, Abbe number, a focal length, and the like) of each lens are listed in Table 9.

TABLE 9

| | | | | | | | Major Axis | Minor Axis |
|---|---|---|---|---|---|---|---|---|
| Surface | | Radius of | Thickness or | Refractive | Abbe | Focal | Effective | Effective |
| No. | Remark | Curvature | Distance | Index | Number | Length | Radius | Radius |
| S1 | First | 4.889 | 2.000 | 1.546 | 56.0 | 7.8886 | 3.2 | 2.5 |
| | Lens | | | | | | | |
| S2 | | −30.844 | 0.100 | | | | 3.045 | 2.5 |
| S3 | Second | 55.102 | 1.117 | 1.644 | 23.5 | −11.659 | 2.913 | 2.5 |
| | Lens | | | | | | | |
| S4 | | 6.556 | 2.104 | | | | 2.449 | 2.5 |
| S5 | Third | 11.411 | 0.929 | 1.570 | 37.4 | 244.494 | 2.235 | |
| | Lens | | | | | | | |
| S6 | | 12.062 | 0.497 | | | | 2.097 | |
| S7 | Fourth | −7.126 | 0.715 | 1.677 | 19.2 | 47.1996 | 2.097 | |
| | Lens | | | | | | | |
| S8 | | −6.062 | 1.550 | | | | 2.210 | |
| S9 | Fifth | 19.884 | 0.989 | 1.537 | 55.7 | −20.068 | 2.652 | |
| | Lens | | | | | | | |
| S10 | | 6.864 | 0.733 | | | | 2.481 | |
| S11 | Filter | Infinity | 0.110 | 1.518 | 64.2 | | 2.609 | |
| S12 | | Infinity | 5.131 | | | | 2.623 | |
| S13 | Imaging | Infinity | | | | | | |
| | Plane | | | | | | | |

An overall focal length f of the optical system according to the fifth example is 17 mm, 2×IMG HT is 7.06 mm, and f12 is 15.891 mm.

In the fifth example, the first lens 510 may have a positive refractive power, and first and second surfaces of the first lens 510 may be convex.

The second lens 520 may have a negative refractive power, a first surface of the second lens 520 may be convex, and a second surface of the second lens 520 may be concave.

The third lens 530 may have a positive refractive power, a first surface of the third lens 530 may be convex, and a second surface of the third lens 530 may be concave.

The fourth lens 540 may have a positive refractive power, a first surface of the fourth lens 540 may be concave, and a second surface of the fourth lens 540 may be convex.

The fifth lens 550 may have a negative refractive power, a first surface of the fifth lens 550 may be convex, and a second surface of the fifth lens 550 may be concave.

Each surface of the first lens 510 to the fifth lens 550 may have an aspherical coefficient, as listed in Table 10. For example, both object-side surfaces and image-side surfaces of the first lens 510 to the fifth lens 550 may be aspherical.

TABLE 10

| | S1 | S2 | S3 | S4 | S5 |
|---|---|---|---|---|---|
| Conic Constant(K) | −1.128 | 5.262 | −87.373 | 0.125 | −18.142 |
| 4th Coefficient(A) | 7.8362E−04 | −3.7559E−03 | −3.1766E−03 | −3.1573E−04 | −1.8491E−03 |
| 6th Coefficient(B) | −1.3616E−04 | 5.1917E−03 | 3.7810E−03 | −1.4224E−06 | −3.4988E−05 |
| 8th Coefficient(C) | 2.9111E−04 | −3.8609E−03 | −2.4429E−03 | −4.1557E−06 | 2.4689E−05 |
| 10th Coefficient(D) | −2.4944E−04 | 1.9265E−03 | 8.8834E−04 | −1.9509E−07 | 2.4367E−06 |
| 12th Coefficient(E) | 1.2963E−04 | −6.8015E−04 | −1.2612E−04 | 2.2367E−08 | 2.2573E−07 |
| 14th Coefficient(F) | −4.5221E−05 | 1.7321E−04 | −4.1514E−05 | −1.0640E−08 | −1.3787E−08 |
| 16th Coefficient(G) | 1.1058E−05 | −3.2061E−05 | 2.8502E−05 | −3.8336E−10 | −1.0665E−08 |
| 18th Coefficient(H) | −1.9352E−06 | 4.3140E−06 | −8.1332E−06 | 2.0586E−10 | 3.0933E−11 |
| 20th Coefficient(J) | 2.4380E−07 | −4.1835E−07 | 1.4380E−06 | 4.3010E−12 | 5.0819E−10 |
| 22nd Coefficient(L) | −2.1938E−08 | 2.8637E−08 | −1.6965E−07 | | |
| 24th Coefficient(M) | 1.3755E−09 | −1.3294E−09 | 1.3429E−08 | | |
| 26th Coefficient(N) | −5.7082E−11 | 3.8810E−11 | −6.8724E−10 | | |
| 28th Coefficient(O) | 1.4087E−12 | −6.0975E−13 | 2.0596E−11 | | |
| 30th Coefficient(P) | −1.5644E−14 | 3.3802E−15 | −2.7490E−13 | | |
| | S6 | S7 | S8 | S9 | S10 |
| Conic Constant(K) | −2.034 | −0.085 | −0.702 | 56.709 | −10.540 |
| 4th Coefficient(A) | −1.4821E−03 | 3.9357E−03 | 5.4656E−04 | −2.0639E−02 | −1.4630E−02 |
| 6th Coefficient(B) | −1.1320E−02 | −9.4654E−03 | 1.3061E−05 | 3.3183E−03 | 4.0414E−03 |
| 8th Coefficient(C) | 2.9244E−02 | 2.3992E−02 | −1.7180E−05 | −2.1900E−03 | −3.6592E−03 |
| 10th Coefficient(D) | −4.7592E−02 | −4.1223E−02 | −5.1951E−06 | 1.1988E−03 | 3.1884E−03 |
| 12th Coefficient(E) | 5.0560E−02 | 4.7368E−02 | −7.3549E−07 | 4.2966E−04 | −2.0462E−03 |
| 14th Coefficient(F) | −3.5905E−02 | −3.7452E−02 | −5.1680E−08 | 9.6077E−05 | 9.5264E−04 |
| 16th Coefficient(G) | 1.7110E−02 | 2.0752E−02 | −1.7297E−09 | −1.3011E−05 | −3.2264E−04 |
| 18th Coefficient(H) | −5.2979E−03 | −8.1115E−03 | 1.0170E−09 | 9.8065E−07 | 7.9442E−05 |
| 20th Coefficient(J) | 9.3377E−04 | 2.2199E−03 | 3.9230E−10 | −3.1686E−08 | −1.4131E−05 |
| 22nd Coefficient(L) | −3.0979E−05 | −4.1433E−04 | | | 1.7896E−06 |
| 24th Coefficient(M) | −2.5822E−05 | 4.9719E−05 | | | −1.5684E−07 |
| 26th Coefficient(N) | 6.1766E−06 | −3.3462E−06 | | | 9.0183E−09 |
| 28th Coefficient(O) | −6.1923E−07 | 7.8088E−08 | | | −3.0548E−10 |
| 30th Coefficient(P) | 2.4521E−08 | 1.9251E−09 | | | 4.6134E−12 |

The above-configured optical system may have aberration characteristics illustrated in FIG. 10.

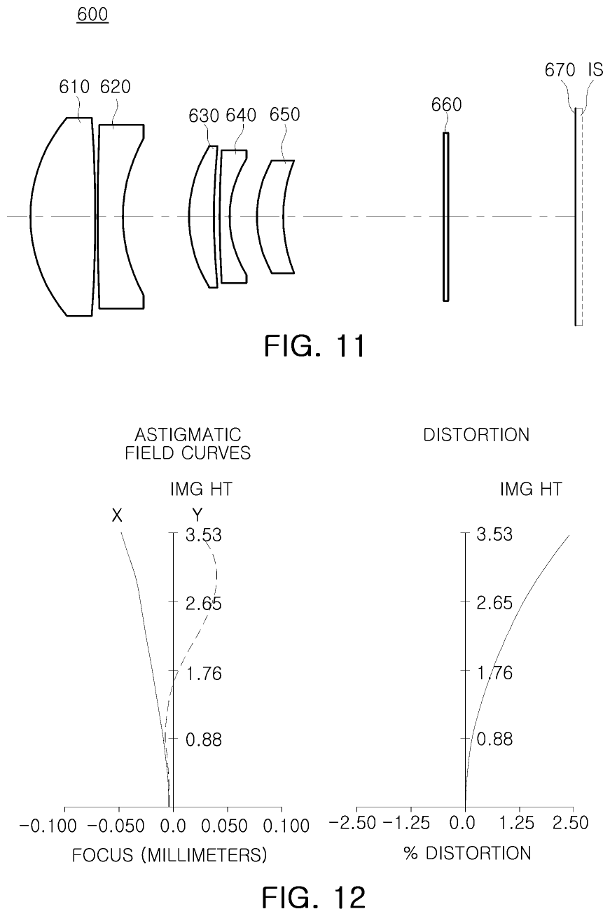

An optical imaging system according to a sixth example will be described with reference to FIGS. 11 and 12.

An optical imaging system 600 according to the sixth example may include a first lens 610, a second lens 620, a third lens 630, a fourth lens 640, and a fifth lens 650, and may further include a filter 660 and an image sensor IS.

The optical imaging system according to the sixth example may form a focus on the imaging plane 670. The imaging plane 670 may refer to a surface on which a focus is formed by an optical imaging system. For example, the imaging plane 670 may refer to one surface of the image sensor IS on which light is received.

Although not illustrated in FIG. 11, the optical imaging system may further include a reflective member R disposed in front of the first lens 610 and having a reflective surface changing an optical path. In the sixth example, the reflective member R may be a prism, but may also be provided as a mirror.

Lens characteristics (a radius of curvature, a thickness of a lens or a distance between lenses, a refractive index, Abbe number, a focal length, and the like) of each lens are listed in Table 11.

TABLE 11

| | | | | | | | | Minor |
|---|---|---|---|---|---|---|---|---|
| Surface | | Radius of | Thickness or | Refractive | Abbe | Focal | Major Axis | Axis Effective |
| No. | Remark | Curvature | Distance | Index | Number | Length | Effective Radius | Radius |
| S1 | First | 4.880 | 2.000 | 1.537 | 55.7 | 8.8964 | 3.269 | 2.5 |
| | Lens | | | | | | | |
| S2 | | −188.019 | 0.100 | | | | 3.077 | 2.5 |
| S3 | Second | 90.059 | 0.800 | 1.646 | 23.5 | −9.5088 | 2.978 | 2.5 |
| | Lens | | | | | | | |
| S4 | | 5.727 | 1.991 | | | | 2.594 | 2.5 |
| S5 | Third | 4.453 | 0.800 | 1.668 | 20.4 | 8.0435 | 2.335 | |
| | Lens | | | | | | | |
| S6 | | 24.092 | 0.168 | | | | 2.244 | |
| S7 | Fourth | 22.429 | 0.326 | 1.646 | 23.5 | −6.5567 | 2.183 | |
| | Lens | | | | | | | |
| S8 | | 3.540 | 0.820 | | | | 1.974 | |
| S9 | Fifth | 3.294 | 0.800 | 1.547 | 56.1 | 19.7697 | 1.85 | |
| | Lens | | | | | | | |
| S10 | | 4.333 | 5.000 | | | | 1.846 | |
| S11 | Filter | Infinity | 0.110 | 1.518 | 64.2 | | 2.850 | |
| S12 | | Infinity | 3.898 | | | | 2.865 | |
| S13 | Imaging | Infinity | | | | | | |
| | Plane | | | | | | | |

An overall focal length f of the optical system according to the sixth example is 17 mm, 2×IMG HT is 7.06 mm, and f12 is 33.747 mm.

In the sixth example, the first lens 610 may have a positive refractive power, and first and second surfaces of the first lens 610 may be convex.

The second lens 620 may have a negative refractive power, a first surface of the second lens 620 may be convex, and a second surface of the third lens 620 may be concave.

The third lens 630 may have a positive refractive power, a first surface of the third lens 630 may be convex, and a second surface of the third lens 630 may be concave.

The fourth lens 640 may have a negative refractive power, a first surface of the fourth lens 640 may be convex, and a second surface of the fourth lens 640 may be concave.

The fifth lens 650 may have a positive refractive power, a first surface of the fifth lens 650 may be convex, and a second surface of the fifth lens 650 may be concave.

Each surface of the first lens 610 to the fifth lens 650 may have an aspherical coefficient, as listed in Table 12. For example, both object-side surfaces and image-side surfaces of the lenses other than the second lens 620 may be aspherical. In addition, an object-side surface of the second lens 620 may be aspherical.

TABLE 12

| | S1 | S2 | S3 | S4 | S5 |
|---|---|---|---|---|---|
| Conic Constant(K) | −0.609 | −46.486 | 6.679 | 0.000 | 0.225 |
| 4th Coefficient(A) | 3.7620E−04 | −8.0000E−05 | 1.3012E−04 | | −3.3806E−03 |
| 6th Coefficient(B) | −7.0000E−06 | −2.0000E−06 | −1.0000E−06 | | 2.9845E−04 |
| 8th Coefficient(C) | 4.1307E−07 | −1.0000E−06 | 1.0000E−06 | | 9.0000E−06 |
| 10th Coefficient(D) | −5.8734E−09 | −5.3165E−08 | 2.5066E−09 | | 3.0000E−06 |
| 12th Coefficient(E) | −1.3689E−08 | −5.3335E−09 | −1.0599E−09 | | 1.0000E−06 |
| 14th Coefficient(F) | −1.5377E−10 | −4.3799E−10 | −2.8124E−10 | | −3.0990E−08 |
| 16th Coefficient(G) | 0.0000E+00 | −3.0303E−11 | −3.9855E−11 | | −8.2117E−09 |
| 18th Coefficient(H) | 0.0000E+00 | −1.0194E−12 | −1.4372E−12 | | −2.3064E−09 |
| 20th Coefficient(J) | 0.0000E+00 | 2.9293E−13 | 2.2182E−13 | | 2.6919E−10 |
| Conic Constant(K) | S6 | S7 | S8 | S9 | S10 |
| 4th Coefficient(A) | 90.471 | 44.674 | −0.225 | −2.435 | −1.620 |
| 6th Coefficient(B) | −2.9914E−03 | −2.1818E−03 | −8.0376E−03 | 8.5000E−05 | 1.5284E−03 |
| 8th Coefficient(C) | 4.3784E−04 | 2.0000E−05 | 4.8393E−04 | −1.3666E−04 | −3.6429E−04 |
| 10th Coefficient(D) | 5.0000E−06 | 6.8000E−05 | 8.0000E−05 | −2.4000E−05 | −4.0685E−05 |
| 12th Coefficient(E) | 9.0000E−06 | −4.0000E−06 | 4.0000E−06 | 4.5000E−05 | 5.2889E−05 |
| 14th Coefficient(F) | 1.0000E−06 | 2.3790E−07 | −1.0000E−05 | −1.0000E−05 | −1.1274E−05 |
| 16th Coefficient(G) | −2.9173E−07 | −3.5690E−07 | 2.0000E−06 | −1.3069E−15 | −4.2608E−16 |
| 18th Coefficient(H) | −8.1206E−08 | −5.2376E−08 | −1.6641E−07 | −4.6191E−17 | −4.1562E−17 |
| 20th Coefficient(J) | −6.8270E−09 | −8.6691E−09 | 1.6599E−09 | −2.0003E−18 | −2.4078E−18 |
| 22nd Coefficient(L) | 2.3064E−09 | 3.3013E−09 | 1.0462E−09 | −1.3966E−19 | −1.4770E−19 |

The above-configured optical system may have aberration characteristics illustrated in FIG. 12.

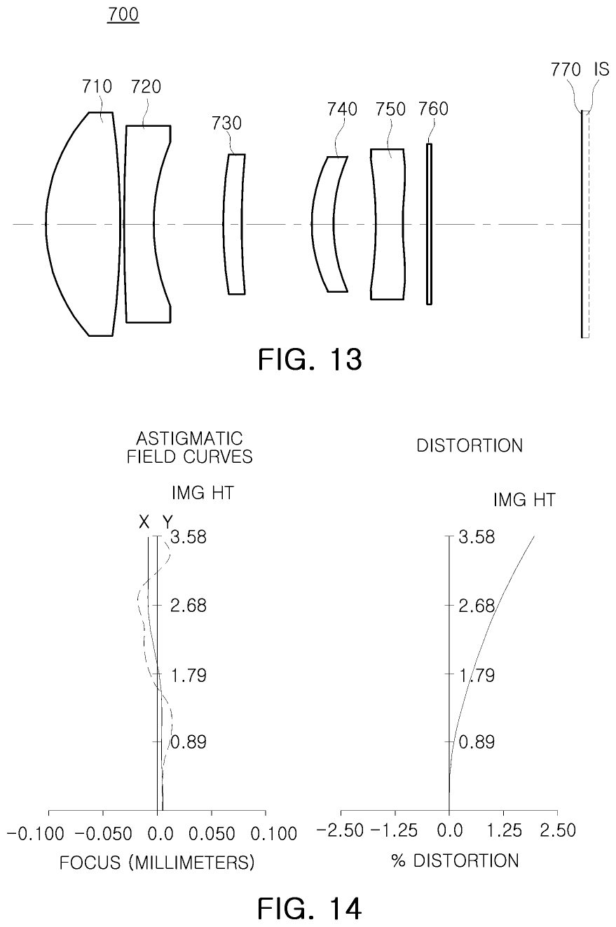

An optical imaging system according to a seventh example will be described with reference to FIGS. 13 and 14.

An optical imaging system 700 according to the seventh example may include a first lens 710, a second lens 720, a third lens 730, a fourth lens 740, and a fifth lens 750, and may further include a filter 760 and an image sensor IS.

The optical imaging system according to the seventh example may form a focus on the imaging plane 770. The imaging plane 770 may refer to a surface on which a focus is formed by the optical imaging system. For example, the imaging plane 770 may refer to one surface of the image sensor IS on which light is received.

Although not illustrated in FIG. 13, the optical imaging system may further include a reflective member R disposed in front of the first lens 710 and having a reflective surface changing an optical path. In the seventh example, the reflective member R may be a prism, but may also be provided as a mirror.

Lens characteristics (a radius of curvature, a thickness of a lens or a distance between lenses, a refractive index, Abbe number, a focal length, and the like) of each lens are listed in Table 13.

TABLE 13

| | | | | | | | Major Axis | Minor Axis |
|---|---|---|---|---|---|---|---|---|
| Surface | | Radius of | Thickness or | Refractive | Abbe | Focal | Effective | Effective |
| No. | Remark | Curvature | Distance | Index | Number | Length | Radius | Radius |
| S1 | First | 4.983 | 2.212 | 1.546 | 56.0 | 7.9371 | 3.5 | 2.5 |
| | Lens | | | | | | | |
| S2 | | −27.962 | 0.111 | | | | 3.286 | 2.5 |
| S3 | Second | 91.623 | 0.887 | 1.644 | 23.5 | −11.262 | 3.071 | 2.5 |
| | Lens | | | | | | | |
| S4 | | 6.696 | 2.056 | | | | 2.600 | 2.5 |
| S5 | Third | 10.971 | 0.519 | 1.570 | 37.4 | −179.63 | 2.194 | |
| | Lens | | | | | | | |
| S6 | | 9.738 | 2.098 | | | | 2.097 | |
| S7 | Fourth | 4.939 | 0.672 | 1.677 | 19.2 | 40.9355 | 2.1 | |
| | Lens | | | | | | | |
| S8 | | 5.680 | 1.225 | | | | 2.028 | |
| S9 | Fifth | 17.705 | 0.800 | 1.537 | 55.7 | −23.393 | 2.128 | |
| | Lens | | | | | | | |
| S10 | | 7.229 | 0.733 | | | | 2.329 | |
| S11 | Filter | Infinity | 0.110 | 1.518 | 64.2 | | 2.493 | |
| S12 | | Infinity | 4.443 | | | | 2.510 | |
| S13 | Imaging | Infinity | | | | | | |
| | Plane | | | | | | | |

An overall focal length f of the optical imaging system according to the seventh example is 17 mm, 2×IMG HT is 7.06 mm, and f12 is 16.98 mm.

In the seventh example, the first lens 710 may have a positive refractive power, and first and second surfaces of the first lens 710 may be convex.

The second lens 720 may have a negative refractive power, a first surface of the second lens 720 may be convex, and a second surface of the second lens 720 may be concave.

The third lens 730 may have a negative refractive power, a first surface of the third lens 730 may be convex, and a second surface of the third lens 730 may be concave.

The fourth lens 740 may have a positive refractive power, a first surface of the fourth lens 740 may be convex, and a second surface of the fourth lens 740 may be concave.

The fifth lens 750 may have a negative refractive power, a first surface of the fifth lens 750 may be convex, and a second surface of the fifth lens 750 may be concave.

Each surface of the first lens 710 to the fifth lens 750 may have an aspherical coefficient, as listed in Table 14. For example, both object-side surfaces and image-side surfaces of the first lens 710 to the fifth lens 750 may be aspherical.

TABLE 14

| | S1 | S2 | S3 | S4 | S5 |
|---|---|---|---|---|---|
| Conic Constant(K) | −1.142 | −1.075 | 99.000 | 0.205 | −15.050 |
| 4th Coefficient(A) | 8.5020E−04 | −3.2474E−03 | −3.3525E−03 | −2.8010E−04 | −1.8126E−03 |
| 6th Coefficient(B) | −8.2781E−05 | 3.5520E−03 | 3.2501E−03 | 2.2461E−06 | −6.0792E−05 |
| 8th Coefficient(C) | 8.4235E−05 | −1.2645E−03 | −1.0855E−03 | −3.7972E−06 | 1.8008E−05 |
| 10th Coefficient(D) | −3.8283E−05 | −5.2655E−04 | −7.0859E−04 | −1.9754E−07 | 1.3674E−06 |
| 12th Coefficient(E) | 8.8381E−06 | 7.9920E−04 | 9.7805E−04 | 1.4772E−08 | 8.7465E−08 |
| 14th Coefficient(F) | −5.2354E−07 | −4.2346E−04 | −5.3218E−04 | −1.2311E−08 | −3.1404E−08 |
| 16th Coefficient(G) | −2.8317E−07 | 1.3449E−04 | 1.7619E−04 | −6.3601E−10 | −1.3545E−08 |
| 18th Coefficient(H) | 9.3413E−08 | −2.8546E−05 | −3.9154E−05 | 1.7583E−10 | −6.3923E−10 |
| 20th Coefficient(J) | −1.4575E−08 | 4.2014E−06 | 6.0432E−06 | 1.7069E−12 | 3.2342E−10 |
| 22nd Coefficient(L) | 1.3778E−09 | −4.3156E−07 | −6.5142E−07 | | |
| 24th Coefficient(M) | −8.1852E−11 | 3.0420E−08 | 4.8198E−08 | | |
| 26th Coefficient(N) | 2.9484E−12 | −1.4042E−09 | −2.3357E−09 | | |
| 28th Coefficient(O) | −5.7271E−14 | 3.8262E−11 | 6.6812E−11 | | |
| 30th Coefficient(P) | 4.3254E−16 | −4.6677E−13 | −8.5568E−13 | | |
| | S6 | S7 | S8 | S9 | S10 |
| Conic Constant(K) | −3.013 | −0.484 | 0.085 | 42.335 | −14.390 |
| 4th Coefficient(A) | −3.0024E−03 | −5.7610E−04 | −2.2379E−03 | −2.0977E−02 | −1.3897E−02 |
| 6th Coefficient(B) | −7.1550E−03 | −8.5291E−06 | 3.4551E−03 | 3.2932E−03 | 4.3088E−03 |
| 8th Coefficient(C) | 2.4619E−02 | 2.6626E−05 | −1.0208E−02 | −2.2110E−03 | −4.6580E−03 |
| 10th Coefficient(D) | −4.6979E−02 | 7.1139E−06 | 2.0694E−02 | 1.2116E−03 | 4.3947E−03 |
| 12th Coefficient(E) | 5.6747E−02 | 9.1986E−07 | −2.7827E−02 | −4.2492E−04 | −2.9932E−03 |
| 14th Coefficient(F) | −4.6233E−02 | 4.6771E−08 | 2.5601E−02 | 9.6126E−05 | 1.4753E−03 |
| 16th Coefficient(G) | 2.6377E−02 | −3.9421E−09 | −1.6496E−02 | −1.3183E−05 | −5.2769E−04 |
| 18th Coefficient(H) | −1.0748E−02 | −1.8591E−09 | 7.5583E−03 | 9.5323E−07 | 1.3690E−04 |
| 20th Coefficient(J) | 3.1469E−03 | −2.2488E−10 | −2.4731E−03 | −2.5186E−08 | −2.5600E−05 |
| 22nd Coefficient(L) | −6.5700E−04 | | 5.7334E−04 | | 3.3971E−06 |
| 24th Coefficient(M) | 9.5450E−05 | | −9.1917E−05 | | −3.1061E−07 |
| 26th Coefficient(N) | −9.1681E−06 | | 9.6872E−06 | | 1.8536E−08 |
| 28th Coefficient(O) | 5.2328E−07 | | −6.0357E−07 | | −6.4802E−10 |
| 30th Coefficient(P) | −1.3435E−08 | | 1.6842E−08 | | 1.0044E−11 |

The above-configured optical system may have aberration characteristics illustrated in FIG. 14.

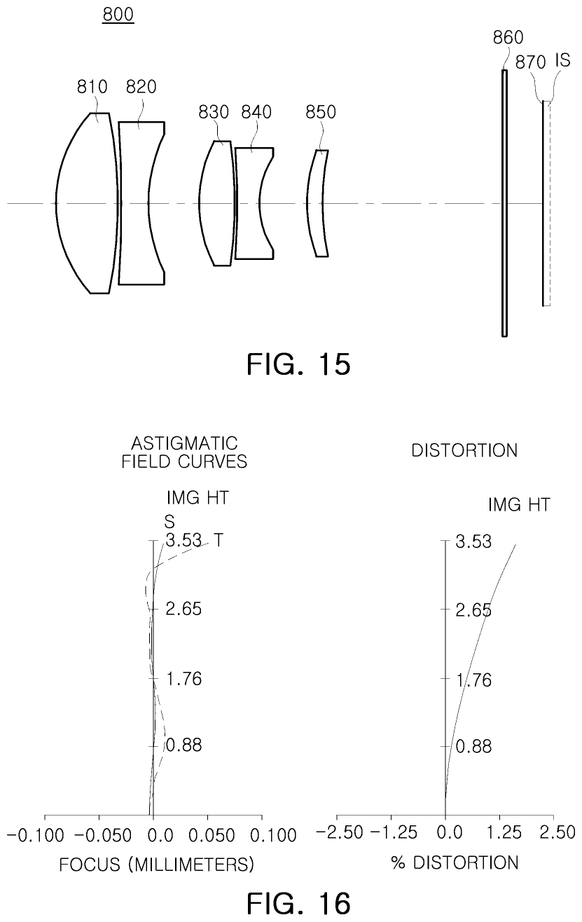

An optical imaging system according to an eighth example will be described with reference to FIGS. 15 and 16.

An optical imaging system 800 according to the eighth example may include a first lens 810, a second lens 820, a third lens 830, a fourth lens 840, and a fifth lens 850, and may further include a filter 860 and an image sensor IS.

The optical imaging system according to the eighth example may form a focal point on the imaging plane 870. The imaging plane 870 may refer to a surface on which a focus is formed by the optical imaging system. For example, the imaging plane 870 may refer to one surface of the image sensor IS on which light is received.

Although not illustrated in FIG. 15, the optical imaging system may further include a reflective member R disposed in front of the first lens 810 and having a reflective surface changing an optical path. In the eighth example, the reflective member R may be a prism, but may also be provided as a mirror.

Lens characteristics (a radius of curvature, a thickness of a lens or a distance between lenses, a refractive index, Abbe number, a focal length, and the like) of each lens are listed in Table 15.

TABLE 15

| | | | | | | | Major Axis | Minor Axis |
|---|---|---|---|---|---|---|---|---|
| Surface | | Radius of | Thickness or | Refractive | Abbe | Focal | Effective | Effective |
| No. | Remark | Curvature | Distance | Index | Number | Length | Radius | Radius |
| S1 | First | 5.089 | 2.154 | 1.546 | 56.0 | 7.3786 | 3.35 | 2.7 |
| | Lens | | | | | | | |
| S2 | | −15.200 | 0.106 | | | | 3.201 | 2.7 |
| S3 | Second | −53.380 | 0.946 | 1.639 | 23.5 | −8.0567 | 3.056 | 2.7 |
| | Lens | | | | | | | |
| S4 | | 5.787 | 1.795 | | | | 2.612 | 2.7 |
| S5 | Third | 5.332 | 1.230 | 1.671 | 19.2 | 6.20891 | 2.341 | |
| | Lens | | | | | | | |
| S6 | | −18.004 | 0.112 | | | | 2.184 | |
| S7 | Fourth | −16.719 | 0.782 | 1.639 | 23.5 | −4.625 | 2.114 | |
| | Lens | | | | | | | |
| S8 | | 3.691 | 1.658 | | | | 1.74 | |
| S9 | Fifth | 4.508 | 0.529 | 1.544 | 56.0 | 26.9261 | 1.96 | |
| | Lens | | | | | | | |
| S10 | | 6.233 | 6.328 | | | | 1.995 | |
| S11 | Filter | Infinity | 0.110 | 1.518 | 64.2 | | 4 | |
| S12 | | Infinity | 1.300 | | | | 4 | |
| S13 | Imaging | Infinity | | | | | | |
| | Plane | | | | | | | |

An overall focal length f of the optical imaging system according to the eighth example is 18 mm, 2×IMG HT is 7.056 mm, and f12 is 22.919 mm.

In the eighth example, the first lens 810 may have a positive refractive power, and first and second surfaces of the first lens 810 may be convex.

The second lens 820 may have a negative refractive power, and first and second surfaces of the second lens 820 may be concave.

The third lens 830 may have a positive refractive power, and first and second surfaces of the third lens 830 may be convex.

The fourth lens 840 may have a negative refractive power, and first and second surfaces of the fourth lens 840 may be concave.

The fifth lens 850 may have a positive refractive power, a first surface of the fifth lens 850 may be convex, and a second surface of the fifth lens 850 may be concave.

Each surface of the first lens 810 to the fifth lens 850 may have an aspherical coefficient, as listed in Table 16. For example, both object-side surfaces and image-side surfaces of the first lens 810 to the fifth lens 850 may be aspherical.

TABLE 16

| | S1 | S2 | S3 | S4 | S5 |
|---|---|---|---|---|---|
| Conic Constant(K) | −0.503 | −25.513 | 35.056 | −2.273 | −0.793 |
| 4th Coefficient(A) | 2.5184E−04 | 1.4614E−04 | −8.5466E−04 | −5.0397E−04 | −2.2790E−04 |
| 6th Coefficient(B) | 9.7340E−06 | 1.3326E−05 | 8.2573E−05 | 7.7641E−05 | 5.8281E−05 |
| 8th Coefficient(C) | 1.1499E−07 | −1.1989E−06 | −1.0511E−06 | 2.0087E−06 | 4.9486E−06 |
| 10th Coefficient(D) | −1.3579E−08 | −7.8332E−08 | 7.3577E−08 | 2.3508E−07 | −2.2206E−06 |
| 12th Coefficient(E) | −9.5188E−09 | −6.4189E−09 | −4.2648E−09 | 7.2646E−08 | 1.0428E−07 |
| 14th Coefficient(F) | −2.8729E−11 | −4.2560E−10 | 3.1548E−10 | 2.6812E−09 | 4.0367E−08 |
| 16th Coefficient(G) | 1.5403E−11 | 2.0914E−11 | 1.4603E−11 | −6.9689E−10 | −8.5377E−10 |
| 18th Coefficient(H) | −4.2213E−13 | −1.9370E−12 | 1.6117E−12 | −6.3728E−11 | −1.3107E−09 |
| 20th Coefficient(J) | −5.3462E−13 | 1.9862E−14 | 4.9327E−14 | 6.5871E−12 | 2.0463E−10 |
| 22nd Coefficient(L) | 1.3778E−09 | −4.3156E−07 | −6.5142E−07 | | |
| 24th Coefficient(M) | −8.1852E−11 | 3.0420E−08 | 4.8198E−08 | | |
| 26th Coefficient(N) | 2.9484E−12 | −1.4042E−09 | −2.3357E−09 | | |
| 28th Coefficient(O) | −5.7271E−14 | 3.8262E−11 | 6.6812E−11 | | |
| 30th Coefficient(P) | 4.3254E−16 | −4.6677E−13 | −8.5568E−13 | | |
| | S6 | S7 | S8 | S9 | S10 |
| Conic Constant(K) | −39.191 | −60.322 | 0.476 | −7.436 | −9.259 |
| 4th Coefficient(A) | 1.3381E−04 | 4.6690E−04 | −2.3283E−03 | −1.1434E−03 | −4.9976E−03 |
| 6th Coefficient(B) | −7.9887E−06 | 2.8513E−05 | −7.1264E−04 | −7.2830E−04 | −2.3047E−04 |
| 8th Coefficient(C) | −2.1787E−06 | 1.0078E−06 | 2.2908E−03 | 1.7912E−04 | 1.6093E−04 |
| 10th Coefficient(D) | −4.1734E−07 | 3.2010E−08 | −2.2196E−03 | −1.7907E−06 | −5.1564E−05 |
| 12th Coefficient(E) | 1.4948E−07 | 2.6330E−07 | 1.3424E−03 | 9.9832E−07 | 1.2463E−05 |
| 14th Coefficient(F) | 3.2988E−08 | 4.8723E−08 | −5.0845E−04 | 1.5078E−06 | 7.7354E−07 |
| 16th Coefficient(G) | 3.8295E−09 | −9.3002E−09 | 1.1807E−04 | −3.1364E−07 | −1.1341E−07 |
| 18th Coefficient(H) | | | −1.5348E−05 | 2.3409E−08 | −7.8189E−08 |
| 20th Coefficient(J) | | | 8.5147E−07 | −2.5995E−09 | 1.0152E−08 |
| 22nd Coefficient(L) | −6.5700E−04 | | 5.7334E−04 | | 3.3971E−06 |
| 24th Coefficient(M) | 9.5450E−05 | | −9.1917E−05 | | −3.1061E−07 |
| 26th Coefficient(N) | −9.1681E−06 | | 9.6872E−06 | | 1.8536E−08 |
| 28th Coefficient(O) | 5.2328E−07 | | −6.0357E−07 | | −6.4802E−10 |
| 30th Coefficient(P) | −1.3435E−08 | | 1.6842E−08 | | 1.0044E−11 |

The above-configured optical system may have aberration characteristic illustrated in FIG. 16.

As described above, an optical imaging system according to an example may have a relatively large overall focal length and may capture high-resolution images.

While specific examples have been shown and described above, it will be apparent after an understanding of this disclosure that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents. Therefore, the scope of the disclosure is defined not by the detailed description, but by the claims and their equivalents, and all variations within the scope of the claims and their equivalents are to be construed as being included in the disclosure.

What is claimed is:

1. An optical imaging system comprising:
a first lens, a second lens, a third lens, a fourth lens, and a fifth lens, sequentially arranged from an object side,
wherein the first lens has a positive refractive power,
wherein the second lens has a negative refractive power,
wherein the third lens has a refractive power,
wherein the fourth lens has a refractive power,
wherein the fifth lens has a refractive power, and
wherein
2.0<f/(2×IMG HT)<3.0, and 0.16<D2/|f2|<0.3,
where f is an overall focal length of the first lens to the fifth lens, IMG HT is half of a diagonal length of an imaging plane, D2 is a distance along an optical axis from an image-side surface of the second lens to an object-side surface of the third lens distance, and f2 is a focal length of the second lens.

2. The optical imaging system of claim 1, wherein
1.7 mm<D2<3.5 mm.

3. The optical imaging system of claim 1, wherein
0.9<f12/f<2.5,
where f12 is a synthetic focal length of the first lens and the second lens.

4. The optical imaging system of claim 3, wherein
7.0<f12/D2<17.0.

5. The optical imaging system of claim 1, wherein
0.6<|f1|/|f2|<1.0,
where f1 is a focal length of the first lens.

6. The optical imaging system of claim 1, wherein
0.8<TTL/f<1.2,
where TTL is a distance along the optical axis from an object-side surface of the first lens to the imaging plane.

7. The optical imaging system of claim 6, wherein
0.7<BFL/(2×IMG HT)<1.5,
where BFL is a distance along the optical axis from an image-side surface of the fifth surface to the imaging plane.

8. The optical imaging system of claim 6, wherein
at least one of 0.3<BFL/TTL<0.6 and 0.4<TD/TTL<0.7,
where BFL is a distance along the optical axis from an image-side surface of the fifth lens to the imaging plane, and TD is a distance along the optical axis from an object-side surface of the first lens to the image-side surface of the fifth lens.

9. The optical imaging system of claim 1, wherein
4.5<n2+n3+n4<5.0,
where n2 is a refractive index of the second lens, n3 is a refractive index of the third lens, and n4 is a refractive index of the fourth lens.

10. The optical imaging system of claim 9, wherein
each of the second to fourth lenses has a refractive index greater than a refractive index of the first lens and a refractive index of the fifth lens.

11. The optical imaging system of claim 10, wherein
each of the second and fourth lenses has a refractive index of 1.64 or more.

12. The optical imaging system of claim 1, wherein
the first lens has a form in which a length in a first axis direction, perpendicular to the optical axis, is greater than a length in a second axis direction, perpendicular to both the optical axis and the first axial direction, and
2.0<f/(2×L1S1el)<2.7,
where L1S1el is a maximum effective radius of an object-side surface of the first lens.

13. The optical imaging system of claim 12, wherein
L1S1el/L1S1es<1.0,
where L1S1es is a minimum effective radius of the object-side surface of the first lens.

14. The optical imaging system of claim 12, wherein
0.9<f1/(2×L1S1el)<2.0,
where f1 is a focal length of the first lens.

15. The optical imaging system of claim 12, wherein
the second lens has a form in which a length in the first axis direction is greater than a length in the second axis direction, and
1.0<L1S1el/L2S1el<1.2,
where L2S1el is a maximum effective radius of an object-side surface of the second lens.

16. The optical imaging system of claim 12, wherein
1.5<L1S1el/Min_el<0.7,
where Min_el is a smallest value, among effective radii of object-side surfaces of the third to fifth lenses.

17. The optical imaging system of claim 1, further comprising an image sensor configured to convert light reflected from an object and refracted by the first lens, the second lens, the third lens, the fourth lens, and the fifth lens, into an electrical signal.

18. An optical imaging system comprising:
a first lens, a second lens, a third lens, a fourth lens, and a fifth lens, sequentially arranged along an optical axis from an object side,
wherein the first lens has a positive refractive power,
wherein the second lens has a negative refractive power,
wherein the third lens has a refractive power,
wherein the fourth lens has a refractive power,
wherein the fifth lens has a refractive power, and
wherein
the first lens has a form in which a length in a first axis direction, perpendicular to the optical axis, is greater than a length in a second axis direction, perpendicular to both the optical axis and the first axial direction, and
2.0<f/(2×L1S1el)<2.7,
where f is an overall focal length of the first lens to the fifth lens, and L1S1el is a maximum effective radius of an object-side surface of the first lens.

19. The optical imaging system of claim 18, wherein
2.0<f/(2×IMG HT)<3.0, and 0.16<D2/|f2|<0.3,
where IMG HT is half of a diagonal length of an imaging plane, D2 is a distance along the optical axis from an image-side surface of the second lens to an object-side surface of the third lens distance, and f2 is a focal length of the second lens.

20. The optical imaging system of claim 19, further comprising an image sensor configured to convert light reflected from an object and refracted by the first lens, the second lens, the third lens, the fourth lens, and the fifth lens, into an electrical signal,
wherein 1.7 mm<D2<3.5 mm.
